(19) United States
(12) Patent Application Publication
(10) Pub. No.: US 2011/0080359 A1
(43) Pub. Date: Apr. 7, 2011

(54) METHOD FOR PROVIDING USER INTERFACE AND MOBILE TERMINAL USING THE SAME

(75) Inventors: Si Hak JANG, Yongin-si (KR); Hyang Ah KIM, Seongnam-si (KR)

(73) Assignee: SAMSUNG ELECTRONICS CO. LTD., Suwon-si (KR)

(21) Appl. No.: 12/884,441

(22) Filed: Sep. 17, 2010

(30) Foreign Application Priority Data
Oct. 7, 2009 (KR) 10-2009-0095322

(51) Int. Cl. G06F 3/041; G06F 3/033; G06F 3/048

(52) U.S. Cl. 345/173; 715/863; 715/790

(57) ABSTRACT

An apparatus and method for providing a user interface for interacting to various touch events detected by multiple touch sensors formed on the different surfaces of a mobile terminal are provided. The method, for a mobile terminal having a first touch area and a second touch area, includes detecting a touch event that includes a first touch sensed on the first touch area and a second touch sensed on the second touch area, identifying a movement pattern of the touch event, and providing a user interface in accordance with the movement pattern. The apparatus and method for providing a user interface according to the present invention is advantageous to input various user commands intuitively using multi-touch gestures and improve utilization of the mobile terminal with enriched emotional expressions.

### PRIORITY

This application claims the benefit under 35 U.S.C. §119(a) of a Korean patent application filed on Oct. 7, 2009 in the Korean Intellectual Property Office and assigned Serial No. 10-2009-0095322, the entire disclosure of which is hereby incorporated by reference.

### BACKGROUND OF THE INVENTION

1. Field of the Invention

The present invention relates to a mobile terminal. More particularly, the present invention relates to an apparatus and method for providing a user interface for responding to various touch events detected by multiple touch sensors formed on different surfaces of a mobile terminal.

2. Description of the Related Art

With the widespread use of mobile telephony, mobile terminals have become essential devices in everyday life. Recently, because touchscreen-enabled mobile terminals are very common, a touch sensor-based User Interface (UI) design has become a key issue.

Typically, touchscreen-enabled mobile terminals are equipped with a single touch sensor wherein the touch sensor detects a command input by the user with a touch gesture such as a tap or a drag. However, the single touch sensor-based input method is limited in detection of various touch gestures. There is therefore a need to develop an apparatus and method for providing a touchscreen-based UI that is capable of interpreting various touch gestures detected on the touchscreen and associating them with user commands.

### SUMMARY OF THE INVENTION

An aspect of the present invention is to address at least the above-mentioned problems and/or disadvantages and to provide at least the advantages described below. Accordingly, an aspect of the present invention is to provide a touchscreen-based user interface method that is capable of inputting various user commands in correspondence to touch gestures sensed by multiple touch sensors.

Another aspect of the present invention is to provide a mobile terminal operating with the touchscreen-based user interface method that is capable of detecting various touch gestures on the touchscreen and interpreting the touch gesture into corresponding user commands.

In accordance with an aspect of the present invention, a method for providing a user interface in a mobile terminal having a first touch area and a second touch area that are formed on opposite surfaces is provided. The method includes detecting a touch event that includes a first touch sensed on the first touch area and a second touch sensed on the second touch area, identifying a movement pattern of the touch event, and providing a user interface in accordance with the movement pattern.

In accordance with another aspect of the present invention, a mobile terminal is provided. The terminal includes a sensing unit including a first touch area and a second touch area that are formed on opposite surfaces of the mobile terminal, a user interface unit for providing a user interface, and a control unit for detecting a touch event that includes a first touch sensed on the first touch area and a second touch sensed on the second touch area, for identifying a movement pattern of the touch event, and for providing a user interface in accordance with the movement pattern.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a mobile terminal having two touch sensors according to an exemplary embodiment of the present invention;

FIG. 2 is a block diagram illustrating a configuration of the mobile terminal of FIG. 1;

FIG. 3 is a flowchart illustrating a method of providing a User Interface (UI) for a mobile terminal using multiple touch sensors according to an exemplary embodiment of the present invention;

FIG. 4 is a flowchart illustrating a method of providing a UI for a mobile terminal using multiple touch sensors according to an exemplary embodiment of the present invention;

FIG. 5 is a diagram illustrating various screens of a mobile terminal during of a UI according to an exemplary embodiment of the present invention;

FIG. 6 is a flowchart illustrating a method of providing a UI for a mobile terminal using multiple touch sensors according to an exemplary embodiment of the present invention;

FIG. 7 is a diagram illustrating various screens of a mobile terminal during operations of a UI according to an exemplary embodiment of the present invention;

FIG. 8 is a diagram illustrating various screens of a mobile terminal during exemplary operation of a UI according to an exemplary embodiment of the present invention;

FIG. 9 is a flowchart illustrating a method of providing a UI for a mobile terminal using multiple touch sensors according to an exemplary embodiment of the present invention;

FIG. 10 is a diagram illustrating various screens of a mobile terminal during operations of a UI according to an exemplary embodiment of the present invention;

FIG. 11 is a flowchart illustrating a method for providing a UI for a mobile terminal using multiple touch sensors according to an exemplary embodiment of the present invention;

FIG. 12 is a diagram illustrating various screens of a mobile terminal during operations of a UI according to an exemplary embodiment of the present invention;

FIG. 13 is a diagram illustrating various screens of a mobile terminal during operation of a UI according to an exemplary embodiment of the present invention;

FIG. 14 is a diagram illustrating various screens of a mobile terminal during operation of a UI according to an exemplary embodiment of the present invention; and

FIG. 15 is a diagram illustrating various screens of a mobile terminal during operation of a UI according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the following description is made under the assumption of a mobile terminal as a mobile phone, the mobile terminal may be any of touchscreen-equipped electronic devices such as cellular phone, Portable Multimedia Player (PMP), Personal Digital Assistant (PDA), Smartphone, MP3 player, and their equivalents. Moreover, although the following description is directed to a bar-type mobile terminal, the present invention is not limited thereto. For example, the present invention may be applied to any of bar-type and slide-type mobile phones. In the following description, the surface having the touchscreen is called ‘front surface’, and the opposite surface is called ‘rear surface.’

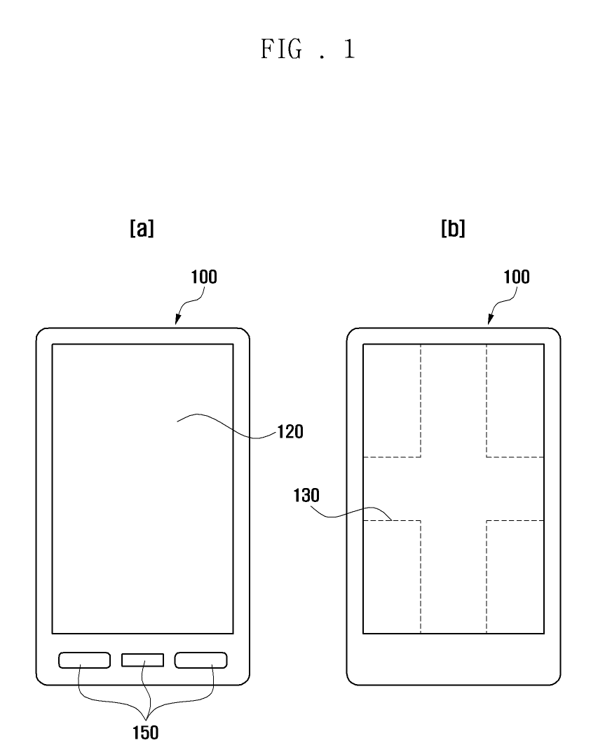

FIG. 1 is a diagram illustrating a mobile terminal having two touch sensors according to an exemplary embodiment of the present invention.

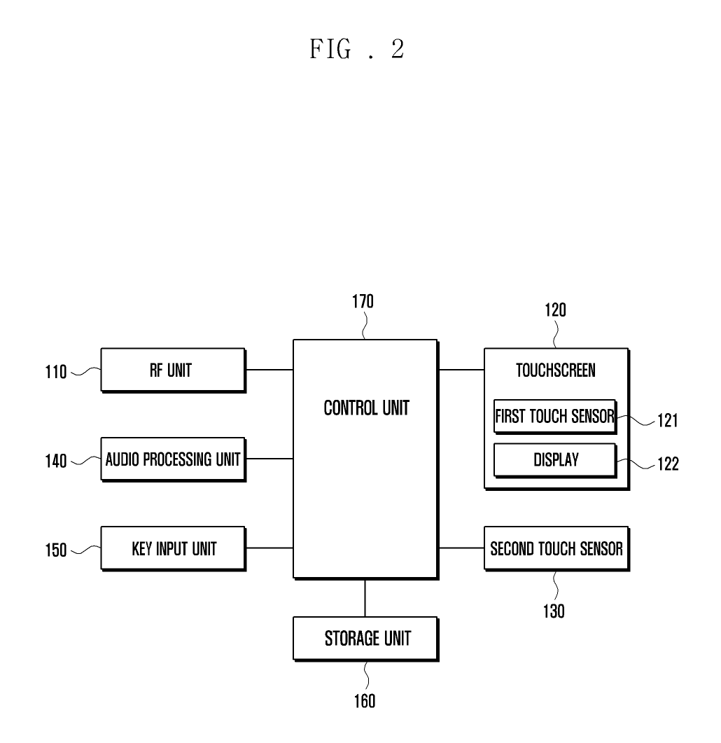

Referring to FIG. 1, frame [a] shows the front surface of a mobile terminal 100. The front surface of the mobile terminal 100 is provided with a touchscreen 120, which is provided with a first touch sensor, and a key input unit 150. Frame [b] of FIG. 1 shows the rear surface of the mobile terminal 100. The rear surface of the mobile terminal 100 is provided with a second touch sensor 130. The first and second touch sensors are located on the front and rear surface of the mobile terminal 100 respectively, and may respectively cover the front and rear surfaces. The internal structure of the mobile terminal 100 is described in more detail with reference to FIG. 2.

FIG. 2 is a block diagram illustrating a configuration of the mobile terminal of FIG. 1.

Referring to FIG. 2, the mobile terminal 100 includes a Radio Frequency (RF) unit 110, a touchscreen 120, a second touch sensor 130, an audio processing unit 140, a key input unit 150, a storage unit 160, and a control unit 170.

The RF unit 110 is responsible for transmitting/receiving radio signals that carry voice and data signals. The RF unit 110 may include an RF transmitter for up-converting and amplifying transmission signals and an RF receiver for low noise amplifying and down-converting received signals. The RF unit 110 delivers the data carried on the radio channel to the control unit 170 and transmits the data output by the control unit 170 over the radio channel.

The touchscreen 120 includes a first touch sensor 121 and a display 122. The first touch sensor 121 senses a touch made on the touchscreen 120. The first touch sensor 121 may be implemented with a touch sensor (such as capacitive overlay, resistive overlay, and infrared beam), a pressure sensor, or other type of sensor that may detect contact or pressure on the screen surface. The first touch sensor 121 generates a signal corresponding to the touch event made on the screen and outputs the signal to the control unit 170.

The display 122 may be implemented with a Liquid Crystal Display (LCD) panel and provide the user with various types of information (such as a menu, input data, function configuration information, execution status, and the like) visually. For example, the display 122 displays the booting progress screen, idle mode screen, call processing screen, application execution screen, and the like.

The second touch sensor 130 may be implemented with a sensing device operating in the same sensing principle with the first touch sensor 121 or in a different sensing principle. In accordance with an exemplary embodiment of the present invention, the second touch sensor 130 arranged on the rear surface of the mobile terminal 100 as shown in frame [b] of FIG. 1. The second touch sensor 130 detects a touch made on the rear surface of the mobile terminal 100 and outputs a corresponding touch signal to the control unit 170. In an exemplary embodiment of the present invention, the second touch sensor 130 may be installed in the form of a quadrangle, a circle, a cross, or any other configuration. In the case of using the form of a cross, the second touch sensor 130 may be implemented to detect a sliding movement of a touch position along the vertical and horizontal bars of the cross.

The audio processing unit 140 includes at least one codec, and the at least one codec may include a data codec for processing packet data and an audio codec for processing audio signal including voice. The audio processing unit 140 converts the digital audio signal to the analog audio signal by means of the audio codec so as to be output through a speaker (not shown) and converts the analog audio signal input through a microphone (not shown) to the digital audio signal. In an exemplary embodiment of the present invention, the display 122 and audio processing unit 140 may be implemented as a User Interface (UI) unit.

The key input unit 150 receives a key signal input by the user and outputs a signal corresponding to the received key signal to the control unit 170. The key input unit 150 may be implemented with a keypad having a plurality of numeric keys and navigation keys along with function keys formed on a side of the mobile terminal. In case that the first and second touch sensors 121 and 130 are configured to generate all of the key signals for controlling the mobile terminal, the key input unit 150 may be omitted.

The storage unit 160 stores application programs and data required for running operations of the mobile terminal. In an exemplary embodiment of the present invention, the storage unit 160 also stores the information related to the UI provision algorithm in correspondence with the pattern of the touch position movement detected by the first and second touch sensors 121 and 130.

The control unit 170 controls operations of the individual function blocks of the mobile terminal. The control unit 170 detects a touch input by the user by means of the first and second touch sensors 121 and 130 and identifies a touch position movement pattern. The control unit 170 controls the display unit 122 and audio processing unit 140 so as to provide the user with a UI corresponding to the identified touch position movement pattern. The control unit 170 can distinguish between different movements of touches on the first and second touch sensors 121 and 130. For example, the control unit 170 can distinguish between the opposite direction movement pattern and the same direction movement pattern of the touch positions on the first and second touch sensors 121 and 130 and the single touch movement pattern, based on the signals provided by the first and second touch sensors 121 and 130. The control unit 170 also can also distinguish among the vertical touch position movement pattern, the horizontal touch position movement pattern, and the circular touch position movement pattern based on the signals provided by the first and second touch sensors 121 and 130. In case that the touch position movement pattern determined only with the signals provided by one of the first and second touch sensors 121 and 130 is recognized, the control unit 170 can identify the touch sensor that provided the signals and determine whether the touch pattern is the vertical touch position movement pattern, the horizontal touch position movement pattern, the circular touch position movement pattern, or any other touch position movement pattern that may be used.

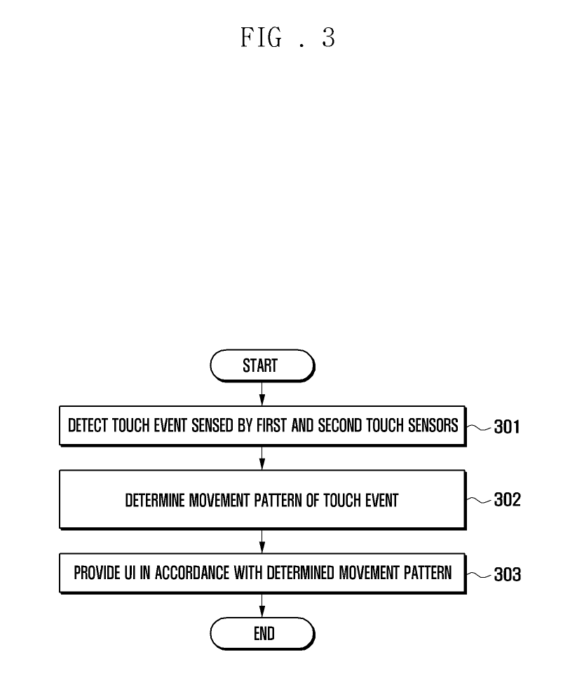

FIG. 3 is a flowchart illustrating a method of providing a UI for a mobile terminal using multiple touch sensors according to an exemplary embodiment of the present invention.

Referring to FIG. 3, the control unit 170 controls the first and second touch sensors 121 and 130 to detect touches in step 301. More specifically, if the user touches the first and second touch areas corresponding to the first and second touch sensors 121 and 130, the first and second touch sensors 121 and 130 detect the touches and send detection signals corresponding to the respective touches to the control unit 170. The control unit 170 receives the detection signals transmitted by the first and second sensors 121 and 130 and identifies the touches made on the first and second touch areas based on the detection signals.

Once the touches are detected, the control unit 170 controls the first and second touch sensors 121 and 130 to detect a pattern of movement of each of the touches on the respective touch areas in step 302. More specifically, if the user moves one or both of the touches without releasing the touches on the first and second touch areas, the first and second touch sensors 121 and 130 detect the movements of the touches on the first and second touch areas and send corresponding detection signals to the control unit 170. In exemplary embodiments of the present invention, the control unit 170 may detect an opposite direction movement pattern, a same direction movement pattern, a single touch movement pattern, or other types of movement patterns based on the detection signals provided by the first and second touch sensors 121 and 130. The control unit 170 also may distinguish among the various types of movement patterns of the individual touches based on the detection signals provided by the first and second touch sensors 121 and 130. In case that a movement pattern made on a single touch area is detected, the control unit 170 may recognize the touch area on which the movement pattern is made and the direction of the movement, e.g., vertical, horizontal, circular, and the like.

After identifying the movement patterns of the touches, the control unit 170 controls to provide the user with a UI corresponding to the movement patterns of the touches in step 303. For example, the control unit 170 may control the display 122, the audio processing unit 140, or any other functional unit of the mobile terminal 100 to provide the user with a UI corresponding to the movement patterns of the touches. According to an exemplary embodiment of the present invention, in a case in which multiple applications are running simultaneously, the control unit 170 may control the display 122 to display the execution windows of the currently running applications in an overlapped manner with a regular distance according to the movement directions and speed of the touch event. According to an exemplary embodiment of the present invention, in a case in which multiple content items are executed simultaneously, the control unit 170 may control the display 122 to display the execution windows of the currently executed content items in an overlapped manner with a regular distance according to the movement direction and speed of the touch event. According to an exemplary embodiment of the present invention, in a case in which a screen lock function is executed, the control unit 170 may unlock the screen lock function and control the display 122 to display the screen on which the screen lock is unlocked. According to an exemplary embodiment of the present invention, in a case in which a music file stored in the mobile terminal is playing, the control unit 170 may control the audio processing unit 140 to adjust the volume of the currently playing music file. According to an exemplary embodiment of the present invention, in a case in which a picture stored in the mobile terminal is displayed, the control unit 170 may control such that the picture is zoomed in or out or moved in the vertical, horizontal, circular or other direction on the display 122. According to an exemplary embodiment of the present invention, in a case in which a picture stored in the mobile terminal 100 is displayed, the control unit 170 may detect a movement of the touch on one of the touch areas and control such that the picture is zoomed in or out, moved in a direction, or changed in viewpoint (in the case of a 3-dimensional image) on the display 122. Four UI provision methods using multiple sensors according exemplary embodiments of the preset invention are described hereinafter.

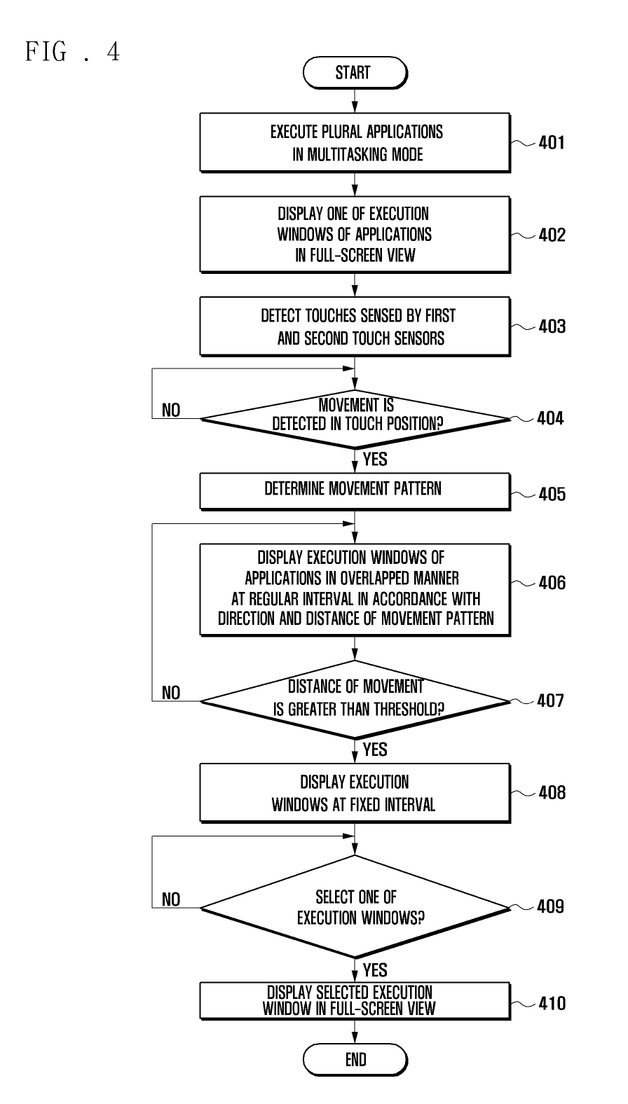

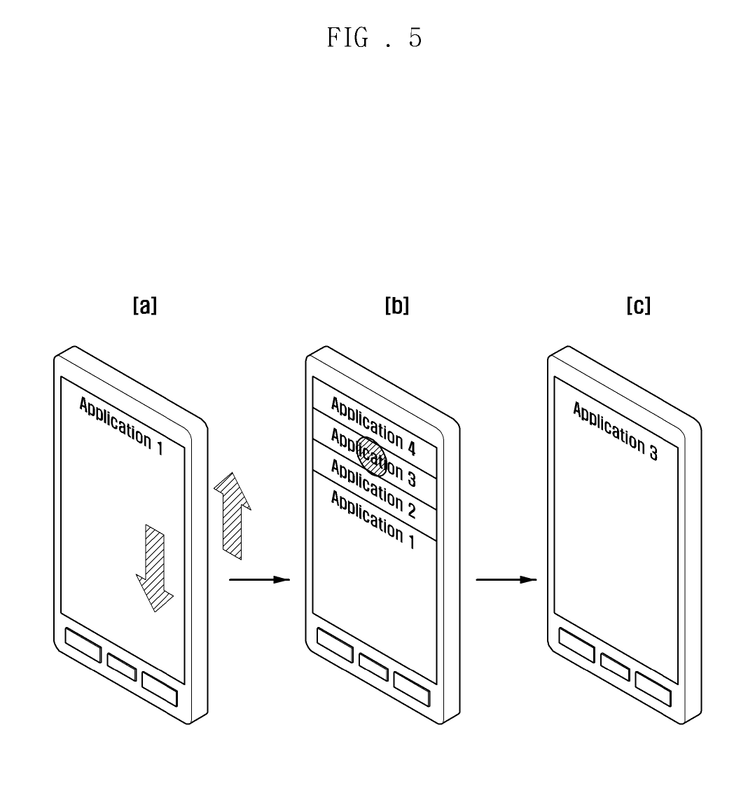

FIG. 4 is a flowchart illustrating a method for providing a UI for a mobile terminal using multiple touch sensors according to an exemplary embodiment of the present invention. FIG. 5 is a diagram illustrating various screens of a mobile terminal during operations of a UI according to an exemplary embodiment of the present invention.

Referring to FIG. 4, the control unit 170 executes a plurality of applications stored in the storage unit 160 in step 401. The control unit 170 may execute all of the applications stored in the mobile terminal selectively to be run simultaneously. In the illustrated exemplary embodiment, it is assumed that the control unit 170 executes application 1, application 2, application 3, and application 4 to run in a multitasking mode.

In step 402, the control unit 170 controls such that the execution window of one of the simultaneously running applications is displayed as a full-screen window on the display 122. For example, the control unit 170 may control such that the execution window of the most recently executed application or the application selected by the user among the simultaneously running applications is displayed as a full-screen window. In the illustrated exemplary embodiment, the description is made under the assumption that the control unit 170 controls to display the execution screen of application 1 in full-screen view at step 402. In frame [a] of FIG. 5, the execution screen of application 1 is displayed in full-screen view.

Returning to FIG. 4, the control unit 170 controls the first and second touch sensors 121 and 130 to detect touches made by the user in step 403. The control unit 170 monitors to determine if movement of at least one of the positions of the touches based on the signals provided by the first and second touch sensors 121 and 130 is detected in step 404. If it is determined in step 404 that a movement of at least one of the touch positions is not detected, the control unit 170 continues executing step 404 until a movement is detected. On the other hand, if it is determined in step 404 that a movement of at least one of the touch positions is detected, the control unit 170 analyzes signals provided by either or both of the first and second touch sensors 121 and 130 to recognize the pattern of the movement of the touch position(s) in step 405. In the illustrated exemplary embodiment, the description is made under the assumption that the touch detected by the first touch sensor 121 moves upward in position and the touch detected by the second touch sensor 130 moves downward in position. Frame [a] of FIG. 5 shows an exemplary case in which the first touch sensor 121 detects upward movement of the touch on the first touch area, and the second touch sensor 130 detects downward movement of the touch on the second touch area.

After determining the movement pattern of the touch position(s) at step 405, the control unit 170 controls such that the execution windows of multiple applications are displayed in an overlapped manner at regular intervals on the display unit 122 in accordance with the movement direction and speed of the touches in step 406. Currently, application 1, application 2, application 3, and application 4 are executed in the mobile terminal and the control unit 170 controls such that the execution windows of application 1, application 2, application 3, and application 4 are displayed in an overlapped manner. In the illustrated exemplary embodiment, the first and second touches are moved upward and downward in position respectively, and the execution windows of application 1, application 2, application 3, and application 4 are displayed in overlapped manner. In the illustrated exemplary embodiment, the control unit 170 controls such that the execution windows of application 1, application 2, application 3, and application 4 are displayed in overlapped manner at a regular interval determined in accordance with the displacements of the touch positions.

In step 407, the control unit 170 determines whether the displacement of one or both of the touch positions is greater than a threshold value. If it is determined in step 407 that the displacement of the touch positions is not greater than the threshold value, the control unit 170 returns to step 406. On the other hand, if it is determined in step 407 that the displacement of one or both of the touch positions is greater than the threshold value, the control unit 170 controls such that the execution windows of the currently running applications are displayed on the display 122 at a fixed interval in step 408. That is, the control unit 170 controls such that, even though the displacement of the movement of at least one of the touches is changed excessively (i.e., greater than the threshold value), the execution windows of the applications are not displayed with too great a distance. As shown in frame [b] of FIG. 5, application 1, application 2, application 3, and application 4 are displayed at a regular interval on the screen.

In step 409, the control unit 170 determines if the first touch sensor 121 detects a touch for selecting one of the execution windows. If it is determined in step 409 that the user makes a touch on the first touch area to select one of the execution windows, the first touch sensor 121 outputs a detection signal to the control unit 170 such that the control unit 170 recognizes the execution window intended by the touch input. Once the execution window is selected, the control unit 170 controls such that the selected execution window is displayed in full-screen view on the display 122. For example, if the user selects the execution window of application 3 while the execution windows of application 1, application 2, application 3, and application 4 are displayed on the screen, the control unit 170 controls such that the execution window of application 3 is displayed in full-screen view. As shown in frame [c] of FIG. 5, the mobile terminal 100 displays the execution window of application 3 in full-screen view.

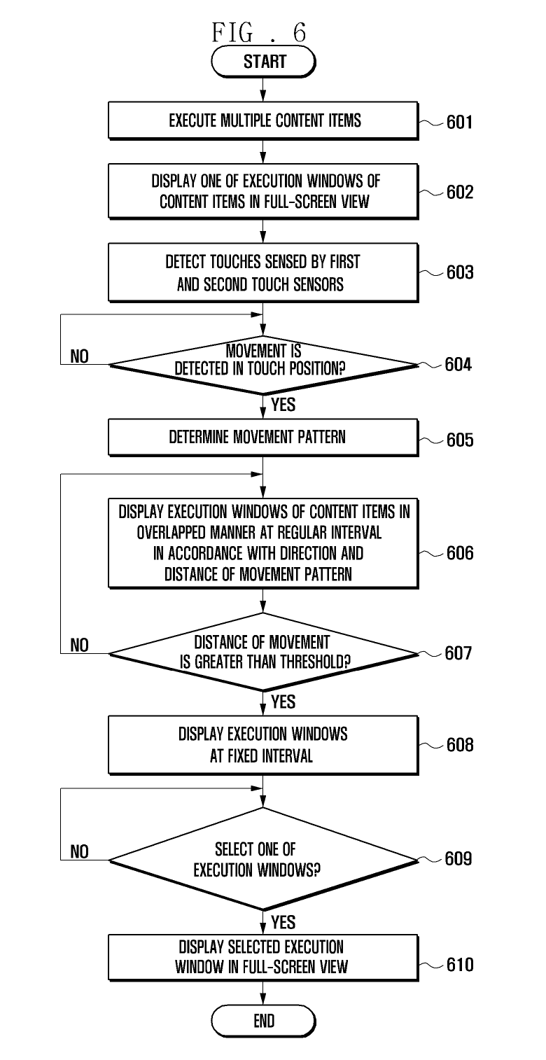

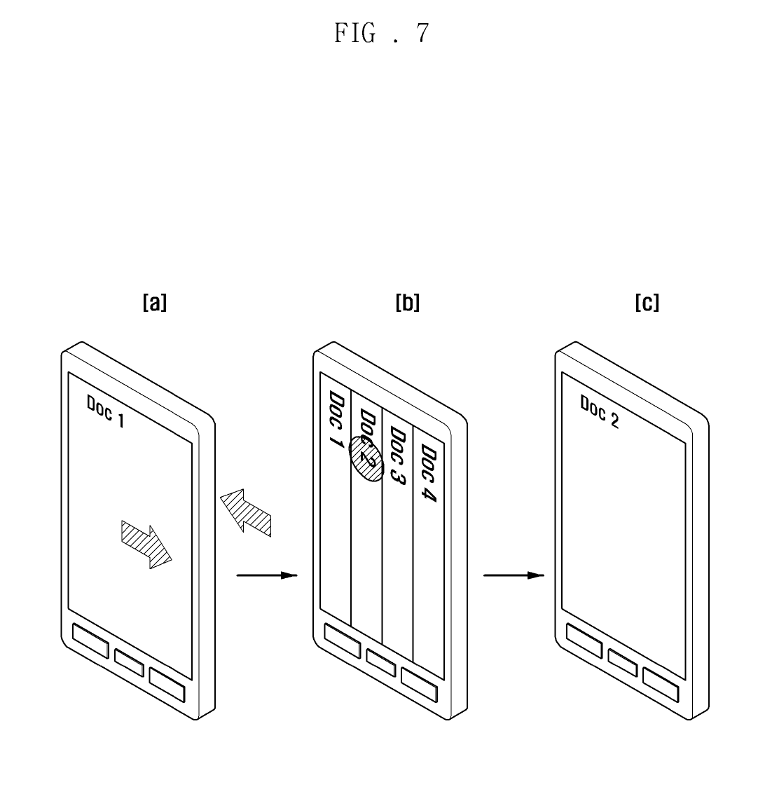

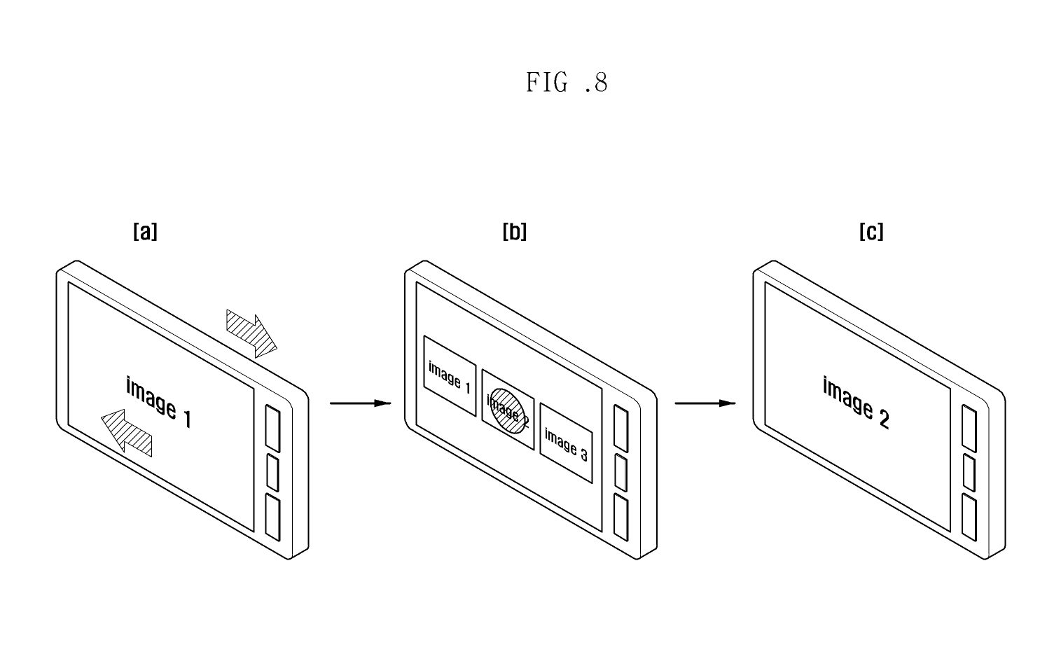

FIG. 6 is a flowchart illustrating a method for providing a UI for a mobile terminal using multiple touch sensors according to an exemplary embodiment of the present invention. FIGS. 7 and 8 are diagrams illustrating various screens of a mobile terminal during operations of a UI according to exemplary embodiments of the present invention.

Referring to FIG. 6, the control unit 170 executes a plurality of content items stored in the storage unit 160 in step 601. In a case in which the content items are document files, the control unit 170 executes the document files selected by the user with a document viewer application. In an exemplary implementation, the description is made under the assumption that the control unit 170 executes the document files Doc 1, Doc 2, Doc 3, and Doc 4 using the document viewer application.

The control unit 170 controls such that the execution window of one of the content items is displayed in full-screen view on the display unit 122 in step 602. In the illustrated exemplary embodiment, the description is made under the assumption that the execution window of Doc 1 is displayed in full-screen view at step 602. In frame [a] of FIG. 7, the execution screen of Doc 1 is displayed in full-screen view.

The control unit 170 controls the first and second touch sensors 121 and 130 to detect touches made by the user on the touch areas in step 603. The control unit 170 monitors to determine if a movement of at least one of the positions of the touches is detected based on the signals provided by the first and second touch sensors 121 and 130 in step 604. If it is determined that a movement of at least one of the touch positions is detected, the control unit 170 analyzes signals provided by the first and second touch sensors 121 and 130 to recognize the pattern of the movement of the touch position(s) in step 605. In the illustrated exemplary embodiment, the description is made under the assumption that the touch detected by the first touch sensor 121 moves rightward in position and the touch detected by the second touch sensor 130 moves leftward in position. Frame [a] of FIG. 7 shows an exemplary case in which the first touch sensor 121 detects rightward movement of the touch on the first touch area and the second touch sensor 130 detects leftward movement of the touch on the second touch area.

After determining the movement pattern of the touch position(s) at step 605, the control unit 170 controls such that the execution windows of the multiple content items are displayed in an overlapped manner at regular intervals on the display unit 122 in accordance with the movement direction and speed of the touches in step 606. Currently, Doc 1, Doc 2, Doc 3, and Doc 4 are executed in the mobile terminal, and the control unit 170 controls such that the execution windows of Doc 1, Doc 2, Doc 3, and Doc 4 are displayed in an overlapped manner. In the illustrated exemplary embodiment, the control unit 170 controls such that the execution windows of Doc 1, Doc 2, Doc 3, and Doc 4 are arranged at regular intervals determined in accordance with the displacements of the touch positions.

Next, the control unit 170 determines whether the displacement of the touch positions is greater than a threshold value in step 607. If it is determined in step 607 that the displacement of the touch positions is greater than the threshold value, the control unit 170 controls such that the execution windows of the multiple content items are displayed at a fixed interval in step 608. As shown in frame [b] of FIG. 7, Doc 1, Doc 2, Doc 3, and Doc 4 are displayed at a regular interval on the screen. On the other hand, if it is determined in step 607 that the displacement of the touch positions is not greater than the threshold value, the control unit 170 returns to step 606.

In step 609, the control unit 170 determines if the first touch sensor 121 detects a touch for selecting one of the execution windows. If it is determined in step 609 that the user makes a touch on the first touch area to select one of the execution windows, the first touch sensor 121 outputs a detection signal to the control unit 170 such that the control unit 170 recognizes the execution window intended by the touch input and displays the selected execution window in full-screen view in step 610. For example, if the user selects the execution window of Doc 2 while the execution windows of Doc 1, Doc 2, Doc 3, and Doc 4 are displayed on the screen, the control unit 170 controls such that the execution window of the Doc 2 is displayed in full-screen view. As shown in frame [c] of FIG. 7, the mobile terminal 100 displays the execution window of Doc 2 in full-screen view. On the other hand, if it is determined in step 609 that the user does not make a touch on the first touch area to select one of the execution windows, the control unit 170 continues executing step 609.

In accordance with an exemplary embodiment of the present invention, the control unit 170 may control such that the execution window displayed in the full-screen view is reduced and thus all of the execution windows of the currently executed content items are displayed on the screen simultaneously. The control unit 170 may also determine whether the displacement of the touch positions is greater than a certain value and, if so, control such that the execution windows are displayed at a fixed interval on the display 122. In an exemplary embodiment in which the control unit 170 executes image files (e.g., image 1, image 2, and image 3) as the content items, the control unit 170 may display the execution window of image 1 in full-screen view on the display 122. If the user makes a touch and moves the touch in position, the control unit 170 may control such that the execution screen of image 1 is reduced and thus the execution windows of image 2 and image 3 are displayed with that of image 1. As shown in frame [a] of FIG. 8, the mobile terminal 100 is positioned in landscape mode with the execution window of image 1 in full-screen view. From this orientation, the user may make a touch event in which two touch positions move in opposite direction horizontally. If such a touch event is detected, the control unit 170 controls such that the execution window of image 1 is reduced to be displayed along with the execution windows of image 2 and image 3 as shown in frame [b] of FIG. 8. If the execution window of image 2 is selected from the screen of frame [b], the control unit 170 controls such that the execution screen of image 2 is enlarged to be displayed in full-screen view as shown in frame [c] of FIG. 8.

In accordance with an exemplary embodiment of the present invention, the mobile terminal 100 may be configured to receive a touch input and provide a UI in response to the touch input according to a combination of the above exemplary embodiments. As an example, it is assumed that during execution of a document viewer application, application 1, application 2, and application 3 are running, Doc 1, Doc 2, Doc 3, and Doc 4 are executed by means of the document view application, and the execution window of the Doc 1 is displayed in full-screen view in the mobile terminal 100. The mobile terminal 100 may be configured such that, if a touch event in which two touch points move in opposite directions vertically is detected by means of the first and second touch sensors 121 and 130, the execution windows of the document viewer application (i.e., application 1, application 2, and application 3) are displayed in an overlapped manner vertically. Also, the mobile terminal 100 may be configured such that, if a touch event in which two touch points move in opposite directions horizontally is detected by means of the first and second touch sensors 121 and 130, the execution windows of Doc 1, Doc 2, Doc 3, and Doc 4 are displayed in an overlapped manner horizontally.

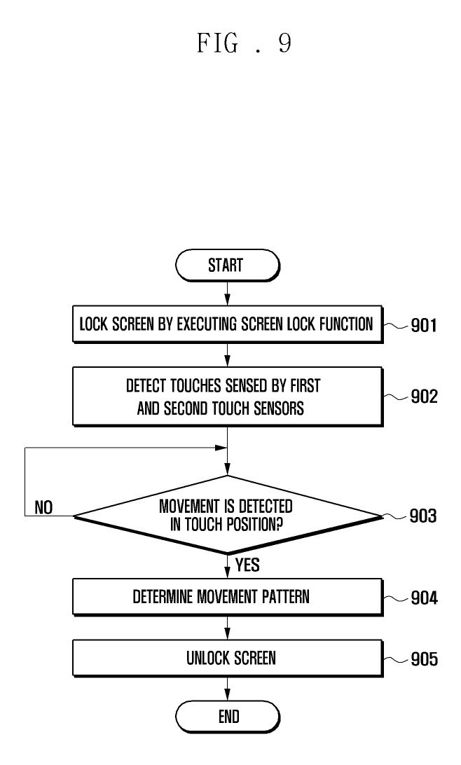

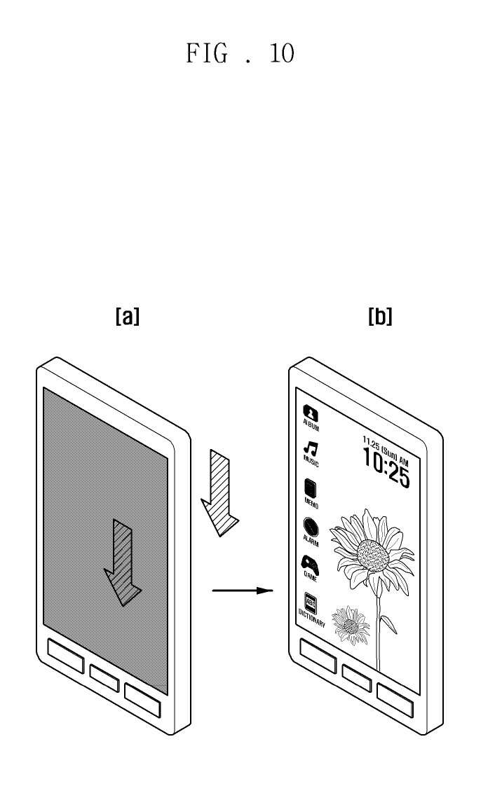

FIG. 9 is a flowchart illustrating a method for providing a UI for a mobile terminal using multiple touch sensors according to an exemplary embodiment of the present invention. FIG. 10 is a diagram illustrating various screens of a mobile terminal during operations of a UI according to an exemplary embodiment of the present invention.

Referring to FIG. 9, the control unit 170 executes a screen lock function to lock the screen in step 901. In frame [a] of FIG. 10, the mobile terminal 100 displays nothing on the screen due to the activation of the screen lock function.

While the screen of the mobile terminal 100 is locked, the control unit 170 controls the first and second touch sensors 121 and 130 to detect a touch event input by the user in step 902. Once a touch event is detected, the control unit 170 determines whether the touch event includes movements of touch positions in step 903. If it is determined in step 903 that the touch event does not include movements of the touch positions, the control unit 170 continues executing step 903. On the other hand, if it is determined in step 903 that the touch event includes movements of the touch positions, the control unit 170 analyzes the movements of the touch positions to determine the movement pattern in step 904. In the illustrated exemplary embodiment, the description is made under the assumption that the touch positions move in the same direction. As shown in frame [a] of FIG. 10, the first and second touch sensors 121 and 130 detect the movements of touch positions in the same direction on the first touch area of the front surface and the second touch area of the rear surface.

If it is determined that the touch positions are moved in the same direction (downward), the control unit 170 unlocks the screen in step 905. After the screen lock is unlocked, the control unit 170 may control such that an idle mode screen is displayed on the display 122. As shown in frame [b] of FIG. 10, if the screen lock is unlocked, the mobile terminal 100 displays an idle mode screen on the display 122. In an exemplary implementation, the mobile terminal 100 may be configured with a threshold value of a displacement between start and end positions of the movement. In this case, the control unit 170 determines whether the displacement of the start and end positions of the touch is greater than the threshold value and unlocks the screen lock only when the displacement of the start and end positions of the touch is greater than the threshold value.

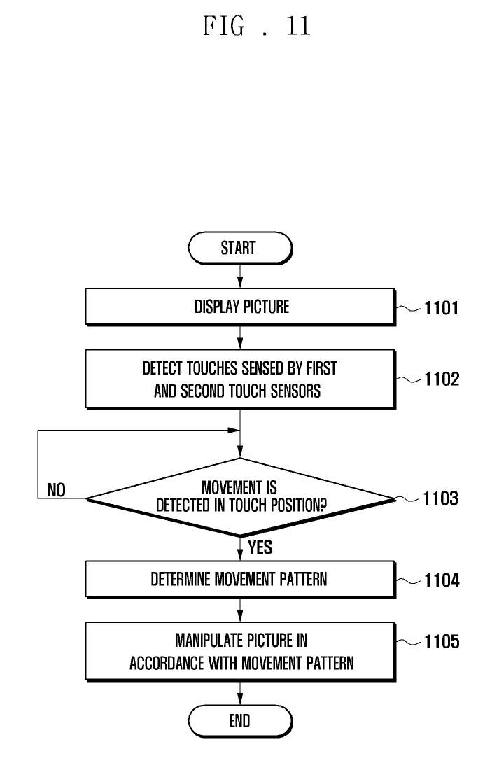

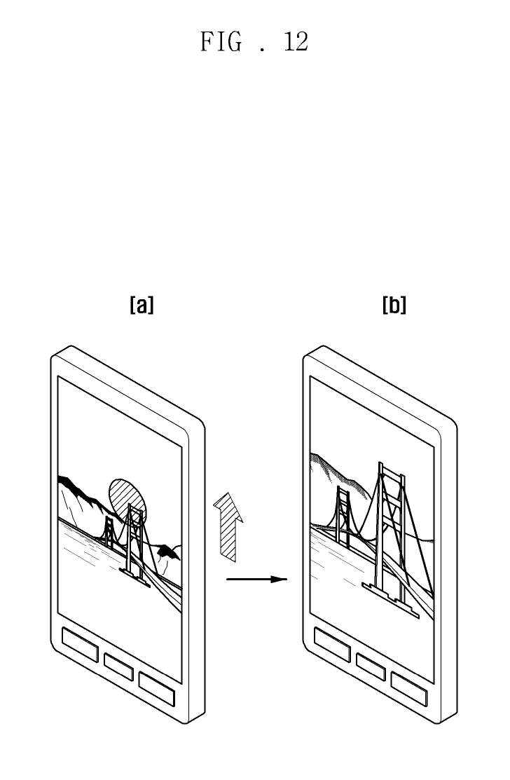

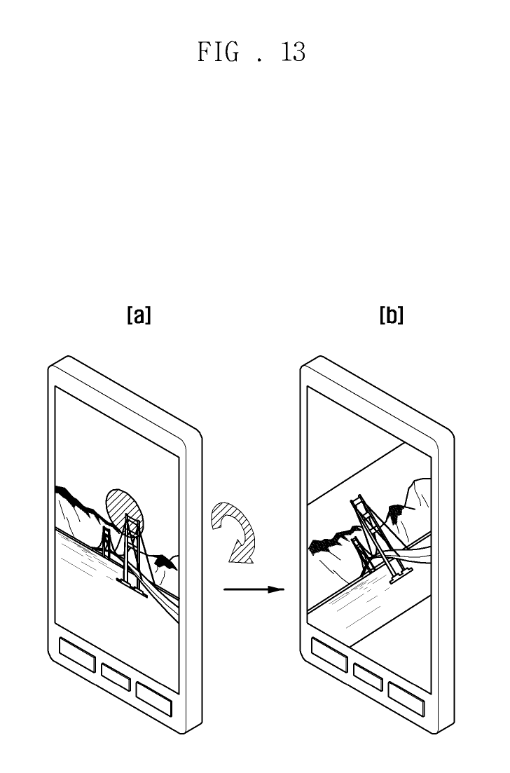

FIG. 11 is a flowchart illustrating a method for providing a UI for a mobile terminal using multiple touch sensors according to an exemplary embodiment of the present invention. FIGS. 12 and 13 are diagrams illustrating various screens of a mobile terminal during operations of a UI according to exemplary embodiments of the present invention.

Referring to FIG. 11, the control unit 170 controls such that one of the pictures stored in the storage unit 160 is displayed on the display 122 in step 1101. In frame [a] of FIGS. 12 and 13, the mobile terminal 100 displays the picture in full-screen view.

In step 1102, the control unit 170 controls the first and second touch sensors 121 and 130 to detect a touch event input by the user and determines whether the touch event includes movement of a touch position in step 1103. If it is determined in step 1103 that the touch event does not include movement of a touch position, the control unit 170 continues execution of step 1103. On the other hand, if it is determined in step 1103 that the touch event includes movement of a touch position, the control unit 170 analyzes the movement of the touch position to determine the pattern of the movement of the touch position in step 1104. Frame [a] of FIG. 12 shows the touch event characterized in that the touch made on the second touch area (corresponding to the second touch sensor 130) moves upward in position while the touch made on the first touch area (corresponding to the first touch sensor 121) is fixed at a position, and frame [a] of FIG. 13 shows the touch event characterized in that the touch made on the second touch area moves circularly while the touch made on the first touch area is fixed at a position.

After the movement pattern of the touch event is determined, the control unit 170 controls such that the picture displayed on the screen is manipulated in accordance with the movement pattern of the touch event in step 1105. In an exemplary implementation, the control unit 170 may control such that the picture is zoomed in or out according to a specific movement pattern. In frame [b] of FIG. 12, the control unit 170 controls such that the picture shown in frame [a] of FIG. 12 is zoomed in according to the movement pattern. In another exemplary implementation, the control unit 170 may control such that the picture is rotated according to the detected movement pattern. In frame [b] of FIG. 13, the control unit 170 controls such that the picture shown in frame [a] of FIG. 13 is rotated according to the detected movement pattern.

In accordance with an exemplary embodiment of the present invention, the mobile terminal may be configured with a threshold value of displacement of the movement of a touch event. In this case, the control unit 170 determines whether the displacement of the movement of the touch event is greater than the threshold value and, if so, controls such that the displayed picture is zoomed in/out, moved, rotated, or otherwise reconfigured.

In accordance with an exemplary embodiment of the present invention, the control unit 170 may distinguish the movement patterns of the touches detected by the first and second touch sensors 121 and 130 and provide a UI that interacts in response to individual movement patterns. For example, the control unit 170 may control such that the picture displayed on the screen scrolls up in response to an upward movement of the single touch made on the first touch area and is zoomed in/out in response to upward movement of the single touch made on the second touch area.

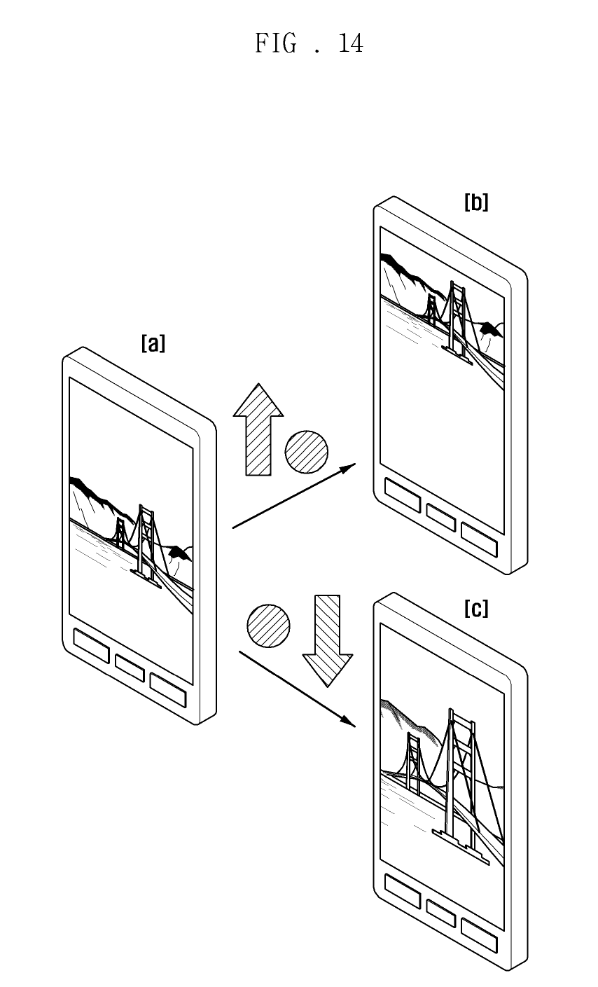

FIG. 14 is a diagram illustrating various screens of a mobile terminal during operations of a UI according to an exemplary embodiment of the present invention.

Referring to FIG. 14, the control unit 170 may control such that the picture shown in frame [a] is scrolled upward as shown in frame [b] of FIG. 14 in response to the upward movement of the touch made on the first touch area without movement of the touch made on the second touch area and is zoomed in as shown in frame [c] of FIG. 14 in response to the downward movement of the touch made on the second touch area without movement of the touch made on the first touch area.

In a case in which the picture displayed in step 1101 is a 3-Dimensional (3D) image, the control unit 170 may control such that the 3D image is scrolled upward in response to the upward movement of the touch made on the first touch area without movement of the touch made on the second touch area and is changed in viewpoint in response to the upward movement of the touch made on the second touch area without movement of the touch made on the first touch area.

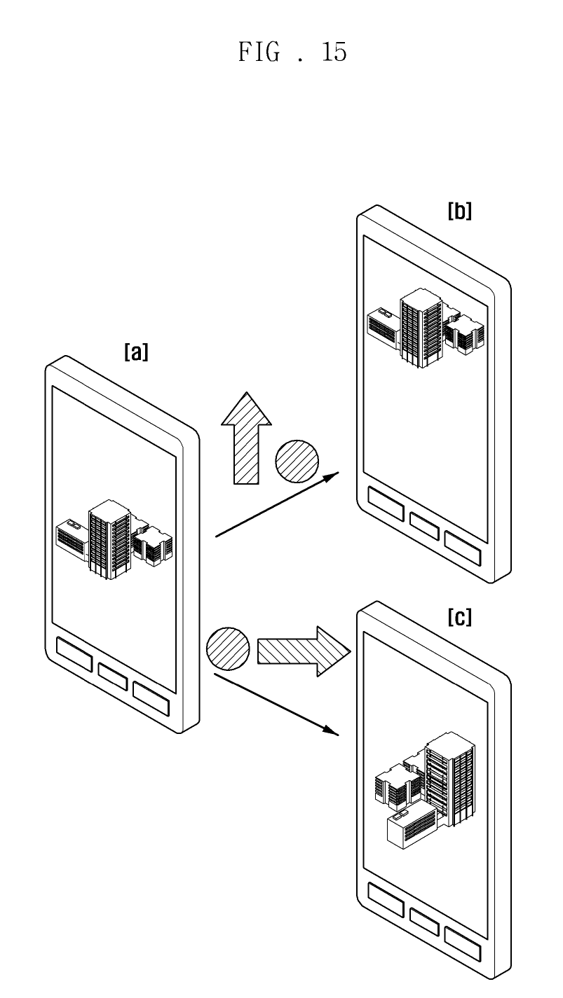

FIG. 15 is a diagram illustrating various screens of a mobile terminal during operation of a UI according an exemplary embodiment of the present invention.

Referring to FIG. 15, the control unit 170 may control such that a 3D picture shown in frame [a] is scrolled upward as shown in frame [b] of FIG. 15 in response to the upward movement of the touch made on the first touch area without movement of the touch made on the second touch area and is changed in viewpoint as shown in frame [c] of FIG. 15 in response to the rightward movement of the touch made on the second touch area without movement of the touch made on the first touch area.

In accordance with an exemplary embodiment of the present invention, if a touch event is detected by means of the first and second touch sensors 121 and 130 while the audio processing unit 140 plays a music file stored in the mobile terminal 100 in step 1101, the control unit 170 determines whether the touch event includes a movement in step 1103, determines, if the touch event includes a movement, the pattern of movement in step 1104, and controls the audio processing unit 140 to adjust the volume of the music file according to the pattern of movement in step 1105.

As described above, the method and mobile terminal for providing user interface according to exemplary embodiments of the present invention are advantageous to input various user commands intuitively using multi-touch gestures and improve utilization of the mobile terminal with enriched emotional expressions. Furthermore, although the above exemplary embodiments associate a specific change in a displayed image or file with a detected change in touch, it is to be understood that these associations are merely for sake of conciseness and not to be construed as limiting. For example, while frames [a] and [b] of FIG. 15 illustrate that a 3D picture is scrolled upward in response to the upward movement of the touch made on the first touch area without movement of the touch made on the second touch area, the present invention is not so limited. That is, in response to the same upward movement on the first touch area without movement on the second touch area, the image may be scrolled downward, rotated or otherwise repositioned or altered. Moreover, the various alterations or repositionings may be set by a manufacturer and/or reset by a user.

While the invention has been shown and described with reference to certain exemplary embodiments thereof, it will be understood by those skilled in the art that various changes in form and details may be made therein without departing from the spirit and scope of the invention, as defined by the appended claims and their equivalents.

What is claimed is:

1. A method for providing a user interface in a mobile terminal having a first touch area and a second touch area that are formed on opposite surfaces, the method comprising:
detecting a touch event that includes a first touch sensed on the first touch area and a second touch sensed on the second touch area;
identifying a movement pattern of the touch event; and
providing a user interface in accordance with the movement pattern.

2. The method of claim 1, wherein the movement pattern comprises at least one of an opposite direction movement pattern in which the first and second touches move in opposite directions, a same direction movement pattern in which the first and second touches move in the same direction, and a single touch movement pattern in which one of the first and second touches moves in a direction while the other stays at a position.

3. The method of claim 1, wherein the movement pattern comprises at least one of a vertical movement pattern in which at least one of the first and second touches moves up and down, a horizontal movement pattern in which at least one of the first and second touches moves left and right, and a circular movement pattern in which at least one of the first and second touches move circularly.

4. The method of claim 2, further comprising:
executing a plurality of applications and content items before the detecting of the touch event; and
displaying an execution window of one of the plurality of applications and content items in response to the touch event.

5. The method of claim 4, wherein the providing of the user interface comprises:
displaying the execution windows of the plurality of applications and content items in overlapped manner at a regular distance in accordance with a direction and speed of the movement pattern.

6. The method of claim 4, wherein the providing of the user interface comprises:
displaying the execution windows of the plurality of applications and content items in overlapped manner at a regular distance in accordance with a direction and distance of the movement pattern;
determining whether the distance of the movement pattern is greater than a threshold value; and
displaying, if the distance of the movement pattern is greater than a threshold value, the execution windows at a fixed interval.

7. The method of claim 2, further comprising:
locking a screen of the mobile terminal by activating a screen lock function before the detecting of the touch event,
wherein the providing of the user interface comprises unlocking the locked screen in response to the touch event.

8. The method of claim 2, further comprising:
playing a music file before the detecting of the touch event,
wherein the proving of the user interface comprises adjusting the volume of the music file being played in response to the touch event.

9. The method of claim 2, further comprising:
displaying a picture before the detecting of the touch event.

10. The method of claim 9, wherein the providing of the user interface comprises one of zooming in and out the picture in response to the touch event.

11. The method of claim 9, wherein the providing of the user interface comprises:
rotating the picture in accordance with the direction of the movement pattern of the touch event.

12. The user method of claim 9, wherein the providing of the user interface comprises:
moving, when the movement pattern is made only with movement of the touch on the first touch area, the picture in accordance with the direction of the movement; and
zooming, when the movement pattern is made only with movement of the touch on the second touch area, the picture in accordance with the direction of the movement.

13. The method of claim 9, wherein the picture comprises a 3-dimensional picture and the providing of the user interface comprises:
moving, when the movement pattern is made only with movement of the touch on the first area, the picture in accordance with the direction of the movement; and
changing, when the movement pattern is made only with movement of the touch on the second touch area, a view point of the 3-dimensional picture in accordance with the direction of the movement.

14. The method of claim 1, wherein the movement pattern comprises movement of the first touch in a first direction and movement of the second touch in a second direction.

15. The method of claim 14, further comprising:
executing at least one application and displaying an execution window of the at least one executed application before the detecting of the touch event, and
wherein the providing of the user interface in accordance with the movement pattern comprises altering the displayed execution window in accordance with the movement pattern.

16. A mobile terminal comprising:
a sensing unit including a first touch area and a second touch area that are formed on opposite surfaces of the mobile terminal;
a user interface unit for providing a user interface; and
a control unit for detecting a touch event that includes a first touch sensed on the first touch area and a second touch sensed on the second touch area, for identifying a movement pattern of the touch event, and for providing a user interface in accordance with the movement pattern.

17. The mobile terminal of claim 16, wherein the control unit distinguishes among an opposite direction movement pattern in which the first and second touches move in opposite directions, a same direction movement pattern in which the first and second touches move in the same direction, and a single touch movement pattern in which one of the first and second touches moves in a direction while the other stays at a position.

18. The mobile terminal of claim 16, wherein the control unit distinguishes among a vertical movement pattern in which at least one of the first and second touches moves up and down, a horizontal movement pattern in which at least one of the first and second touches moves left and right, and a circular movement pattern in which at least one of the first and second touches move circularly.

19. The mobile terminal of claim 16, wherein the movement pattern comprises movement of the first touch in a first direction and movement of the second touch in a second direction.
